(19) United States
(12) Patent Application Publication
(10) Pub. No.: US 2011/0306483 A1
(43) Pub. Date: Dec. 15, 2011

(54) MANUAL SHEET FOLDING DEVICE

(76) Inventor: Joanne Valente, Rochester, NY (US)

(21) Appl. No.: 12/797,353

(22) Filed: Jun. 9, 2010

(51) Int. Cl. B31F 1/00

(52) U.S. Cl. 493/451

(57) ABSTRACT

A manual sheet folding device and process comprising a plurality of hingedly connected panels that provide support for generally rectangular, textile based sheet products. Other embodiments comprise additional or fold-away panels to accommodate generally rectangular sheet products of varying size. The process of using the manual sheet folding device involves a user mounting the sheet product onto the prearranged panel configuration, followed by successively folding the plurality of hingedly connected panels in a predetermined manner, ending with a series of lifting and folding actions resulting in folded product that is dismounted from the sheet folding device.

### FIELD OF THE INVENTION

This invention generally relates to devices and processes for folding sheet like articles such as bottom sheets (fitted), top sheets, blankets, table cloths, drop cloths, tarps, and the like. The invention is especially suited for folding fitted or contoured sheets (e.g. fitted bottom bed sheets that incorporate an elastic type material). The invention is appropriate for low volume folding type of environments.

### BACKGROUND OF THE INVENTION

The present invention is directed to situations where occasional low volume folding is required. Environments with such low folding demands include the home, bed and breakfast establishments, small shops, and the like. In contrast, it is common in high volume folding environments (e.g. textile manufacturing & packaging plants, large hotel laundry departments) to find large, complex, expensive, semiautomatic to fully automated folding machines designed to keep up with the substantially large folding demands. Such high volume folding equipment, though efficient, is not appropriate for the low volume folding environment where article folding is an occasional occurrence. The folding apparatus needs for the occasional use, low volume folding environment is directed to units that are inexpensive, safe, compact, etc., whereas, the high volume folding environments are mainly focused on production or throughput.

Many have experienced the frustration of folding sheets like articles such as bottom sheets (fitted) top sheets, blankets, table cloths, drop cloths, tarps and the like. For many, this is a clumsy task, especially when it comes to fitted sheets, that is, contoured sheets with elasticized bands located on their entire, or a portion, of the sheet's periphery. These bands snugly engage the bottom and/or side of a mattress to prevent slippage and the sheet from dislodging during use. Folding bed sheets is a housekeeping chore that is performed to aid in sheet storage and prevent wrinkled bed coverings. In the commercial or institutional setting, the folding of bed sheets and the like is a housekeeping chore that some workers must regularly and repeatedly endure.

Elderly, frail, invalid or disabled individuals often find it difficult, or even impossible, to lift and stretch articles such as bed sheets in a manner that facilitates easy folding. Some find it difficult to bend at the waist or difficult to use the fingers with precision to fold and manipulate the bed sheet at the corners. Children are well-known to have difficulty folding bed sheets in manner that results in a neat appearance. This can be especially challenging where, as is often the case in children, where the bedding is substantially longer that the child.

A folded sheet product that deviates from the well established rectangular shape tends to yield a disorganized untidy appearance. Similarly, a series of folded products having non-uniform final dimensions is yet another situation that can create an untidy appearance, especially if several folded articles are vertically stacked. Furthermore, stacking folded articles having non-uniform final dimensions often leads to stack instability as well as storage problems. Stack instability can be of particular concern where the folded articles run the risk of being bumped (e.g. retail situations, hotel housekeeping cart, and the like).

Description/discussion of the related art; U.S. Pat. No. 6,814,269 to Fernandez, and U.S. Pat. No. 6,360,927 to Barker describe devices that function in the horizontal position (e.g. tabletop or the like) and are geared toward the folding of upper body garments (e.g. shirts and tops). U.S. Pat. No. 6,685,065 to Ebling et al. discloses a similar folding aid including a telescopically adjustable center member. While, in contrast, U.S. Pat. No. 5,816,434 to Weinstein discloses a folding device having a spring clip and holding bar, where the device is mounted to a vertical surface such as a wall. Both U.S. Pat. No. 6,269,987 to LaPace et al., and U.S. Pat. No. 6,015,069 to Christensen disclose folding devices that are in the form of a table or table like structure. Such designs and the like, do not provide a user with a compact inexpensive folding device for low volume folding situations; furthermore the known difficulties in folding fitted sheets are not addressed. The previous discussion along with the aforementioned references reveals many shortcomings associated with sheet folding aids for low volume folding situations.

The purpose of the present invention is to overcome several of the shortcomings affiliated with the prior art as well as the introduction of additional novel features.

### SUMMARY OF THE INVENTION

The present invention relates to a sheet folding device and method of use for low volume folding environments. The sheet folding device is manipulated in a manual fashion and does not require the use of complex mechanical levers, electromechanical components, or the like.

In accordance with the present invention, and an embodiment thereof, there is provided a sheet folding device essentially comprising a first folding panel pair having a first panel and a second panel, a second folding panel pair having a third panel and a fourth panel, and a third folding panel pair having a fifth panel and a sixth panel, where each pair of the panels associated the folding panel pair are generally rectangular, thin, rigid, and of similar size.

The individual panels in the folding panel pairs increase in size starting with the outermost panels located on the extreme left and right, and progressing to the center panel pair. Such a size coordinated panel progression or layout, configures a nested array that enables the folding and inline nesting of the folding multiple panel pairs atop of one another. Each folding panel pair accommodates a specific range of sheet-product sizes when operating within the nested array framework. Each folding panel pair corresponds to the series of standard commercial sizes used to characterize the size of various products such as small, medium, and large.

Accordingly, it is an object of the present invention to provide an improved folding device for sheet type products, such as fitted sheets, flat sheets, blankets and the like.

It is an object of the present invention to provide a device that saves a user time and effort when folding sheet type products.

It is an object of this invention to provide a device that minimizes the awkward body positions and related strain associated with folding sheet type products.

It is an object of this invention to provide a device that effectively folds sheet type products to a final folded state that is neat appearance, of substantially the same final finished dimensions regardless of original sheet size, and in ready condition for storage.

It is yet another object of the present invention to provide a sheet folding device that is durable and reliable for the occasional low volume folding environment (e.g. the home, bed and breakfast establishments, small shops, and the like).

It is yet another object of the present invention to provide a sheet folding device that is light, portable, and compactly folds for easy storage.

It is yet another object of the present invention to provide a sheet folding device that can be worked by a single user from a standing position, without the use of a tabletop, enabling the user to complete the folding procedure in confining environments having limited working surfaces.

It is yet another object of the present invention to provide a sheet folding device that is constructed from materials that are resistant to long term moisture damage, enabling the user to fold damp sheet type products, in addition to safe storage in damp, humid conditions commonly associated with laundry areas.

It is yet another object of the present invention to provide a sheet folding device and method of using that is able to fold fitted sheets, flat sheets, and other sheet type products that do not neatly fall into one of the aforementioned small, medium, and large size categories.

It is yet another object of this invention to provide a relatively simple sheet folding device that is economical from the viewpoint of the manufacturer and consumer, is susceptible of low manufacturing costs with regard to labor and materials, and which accordingly is then susceptible of low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### PARTICULAR ADVANTAGES OF THE INVENTION

The present invention provides several advantages in a low volume folding environments. The compact, light folding device enables a user to quickly, and consistently fold sheet products and the like, to substantially similar dimensions. The device is particularly useful in folding troublesome fitted sheets. Article(s) folded by the present invention possess a tidy uniform appearance, delivering a message of quality to the onlooker. Furthermore accommodating said folded articles in given storage compartments, closets, housekeeping carts and the like, is streamlined given the folded articles are of all substantially similar dimensions having a generally rectangular geometry.

Also, the device is designed to function while the user is in the standing position, therefore eliminating the need for a table, counter, or the like. This provides users with increased folding location options, for example using the device in confined quarters. Certain device embodiments can accommodate the full range of bed sheets sizes. The device is easily folded into a flatten state for easy storage, additionally preferred materials, such as polymers, provide durability when the device is used and/or stored in high moisture areas.

### BRIEF DESCRIPTION OF THE DRAWINGS

The invention will be described by reference to the specification and the drawings, in which like numerals refer to like elements, and wherein:

FIG. 1A illustrates a perspective front-top view of the sheet folding device showing an embodiment having a nestable array of hingedly connected panels in an open position with panel top edge cut-outs.

FIG. 1B illustrates a front view of the sheet folding device depicting various dimensional properties of various sheet folding device components, and example relative dimensions producing a nestable array of panels.

FIG. 2 illustrates a front view of the sheet folding device without hinges, depicting the three levels of folding panel pairs in their adjacently adjoined orientation.

FIG. 3A illustrates a front view of a large sheet product mounted on a sheet folding device utilizing first, second and third panel pairs.

FIG. 3B illustrates a perspective front-top view of a large sheet product mounted on a sheet folding device in the process of being folded, where second and third panel pairs are both nested against the first panel pair.

FIG. 3C illustrates a top view of a large sheet product mounted on a sheet folding device in the closed position, in the process of being folded, where the first panel pair is in the closed position with second and third panel pairs nested within.

FIG. 3D illustrates a front view of a large sheet product mounted on a sheet folding device where nested array of panels are depicted in the closed position, showing a large sheet is being upwardly removed via first and second access channels.

FIG. 4 illustrates a perspective front-top view of a medium sheet product mounted on the sheet folding device where the third panel pair is folded out of the way to accommodate medium sheet size.

FIG. 5 illustrates a perspective front-top view of a small sheet product mounted on the sheet folding device where the second and third panel pairs are folded out of the way to accommodate small sheet size.

FIG. 6 illustrates a top view of an extruded polymeric hinge with panels attached.

The drawings are not to scale, in fact, some aspects have been emphasized for a better illustration and understanding of the written description. In order to help facilitate the understanding of this disclosure, a parts list numbering convention has been employed. The first digit in three digit part numbers refers to the Figure number where the part was first introduced, or is best depicted. Likewise, in four digit part numbers, the first two digits refer to the Figure number where the part was first introduced, or is best depicted. Although this disclosure may at times deviate from this convention, it is the intention of this numbering convention to assist in an expeditious comprehension of this application.

### DEFINITIONS OF TERMS USED IN THIS SPECIFICATION

The sheet folding device and process thereof in this disclosure shall have equivalent nomenclature including: the sheet folding device, the folding device, the device, or the present invention. Additionally, as it relates to objects with a generally rectangular geometry, the term short dimension, short side, or width shall refer to the shorter or smaller of the two sides or edges of the rectangular object. Whereas, the terms elongated dimension, elongated side, or length shall refer to the longer or larger of the two sides or edges of the rectangular object.

In the area of bedding, there exists dedicated terminology to characterize the size of available products. For example, bedding related sheet products considered of “small” size are described by the terms or categories entitled “Twin” and “Full”; the medium size class of products corresponds to the “Queen” size category; and the large size class of products corresponds to the “Eastern King”, “California King”, or simply “King” size categories.

Also, in this disclosure, the term “exemplary” shall possess only one meaning; wherein the sole definition pertains to serving as an example, instance, or illustration.

### DETAILED DESCRIPTION

In the following is described several embodiments of the Sheet Folding Device of the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

In this context, the Sheet Folding Device may be constructed of any relatively rigid material such as various plastics, polymers, metals, woods, metals, metal alloys, rubbers, synthetic rubbers, rubber-like materials, composite materials, or the like. In preferred embodiments the device would be constructed from moisture resistant, wear-resistant, light weight, rigid, thin materials such as aluminum, ALUMACORR, SINTRA/PVC, Foamboard, GATORFOAM, CORTEX, SIGNBOND, Styrene, PVC foam board, to name a few. For purposes of this application, however, the Sheet Folding Device will be referred to as if constructed from PVC foam board. The PVC foam board is polymer based material that is but one of many preferred material choices that possess many of the aforementioned desired material properties. A specific example of such a PVC foam board material is the Excel PVC Free Foam product, available from the Jain Inc. of Columbus, Ohio. Additionally, by way of example, but not limitation, said Sheet Folding Device may be formed of a moldable high strength, resilient impact resistant plastic material. Optionally the Sheet Folding Device materials aforementioned can be perforated to reduce weight, increase ventilation, and the like.

There are several joint or hinge types that will adequately function in the Sheet Folding Device application, one such example is piano hinge, or continuous hinge in conjunction with appropriate fastening means such as nuts & bolts, screws, rivets, adhesives and the like. Preferred hinge materials include various plastics, polymers, metals, metal alloys, rubbers, synthetic rubbers, rubber-like materials, composite materials or any other materials that possess preferred properties which include moisture resistance, wear-resistance, light weight, rigidity. A preferred hinge design is one that incorporates both the fastening function and the hinge function, thereby streamlining the device design and fabrication thereof. One such example of a preferred combination hinge successfully tested is Plastic Panel Hinge P/N 108-640, available from Outwater Plastics industries Inc. of Bogota, N.J.

Other suitable hinges include butt hinges, slip hinges, flag hinges, liftoff hinges, as well as other hinge types generally known in the industry. Additional methods of providing a reliable hinging means to join the PVC panels, or equivalently create connected panel like segments include the use of polymeric living hinges. Living hinges are generally created by the placement of a thin portion of material bridging two heavier portions of the same material. They provide the ability to flex repeatedly without the use of a classical mechanical hinge. Again, using such a technology, one can construct a device from one continuous piece of polymeric material followed by subsequent hinge creation processes (a well known process in the polymeric industry) potentially leading to a durable inexpensive product.

In another embodiment, the Sheet Folding Device comprises two or more sections cooperatively assembled to the desired configuration. For example, the panels and joints or hinges may be separately manufactured and joined together by known manufacturing methods such as mechanical fasteners, heat welding or by the use of adhesives. These sections can be either temporarily or permanently affixed to each by means known to one skilled in the art.

Many types of sheet type products can be folded using this device. However, this application will generally refer to fitted or contoured sheets which are known to be one of the most challenging types of sheet product to fold uniformly. Yet, it is to be understood that this device can be used to fold flat sheets, duvets, tablecloths, blankets, comforters, oversized towels, bedspreads, drop cloths, tarps, among other relatively large sheet type products. An advantage of using the folding device is that all processed completely folded sheet products folded by the device will all achieve substantially similar final folded dimensions. The relatively uniform condition of the finished (completely folded) sheet products enables enhanced stacking properties, predictable storage strategies (e.g. placement into storage bags, closets, drawers), a neat organized appearance, and the like.

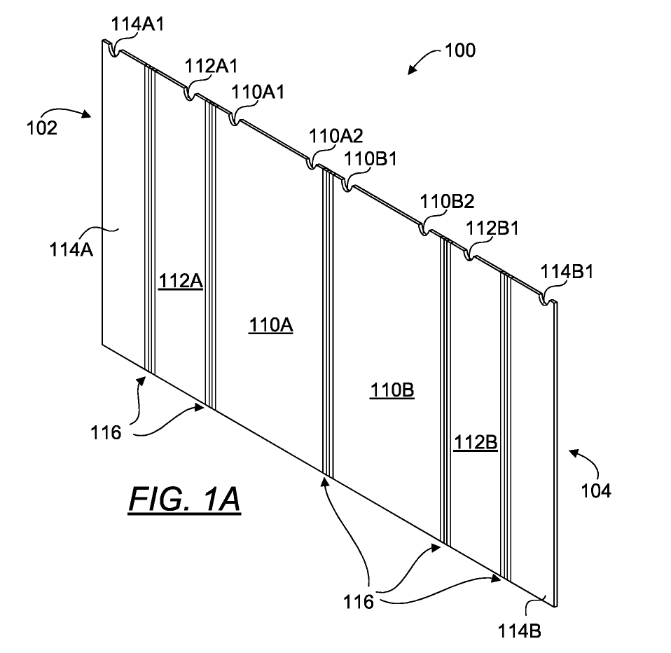

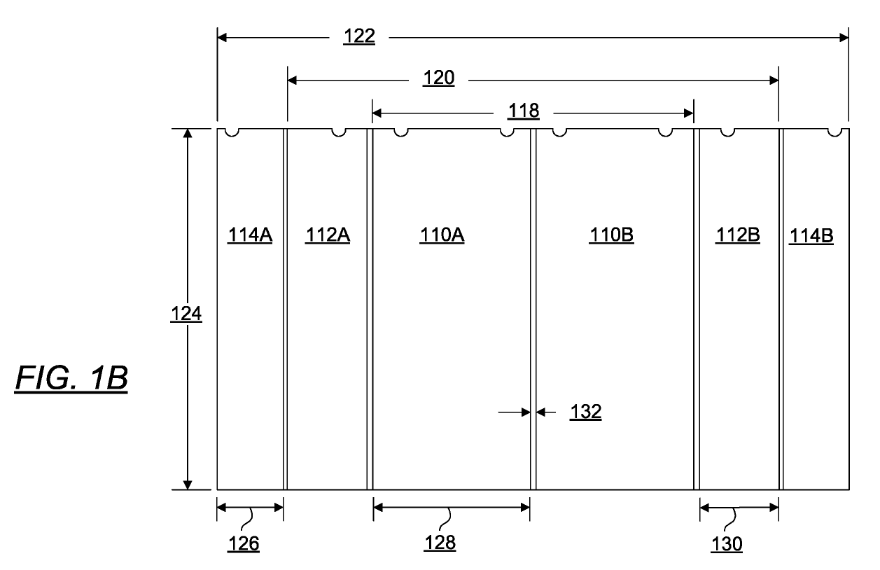

FIGS. 1A and 1B illustrates an overall perspective front-top view and a front view respectively, of the manually operated sheet folding device 100 with hinges 116 in the unfolded condition having a front face 102 and a back face 104.

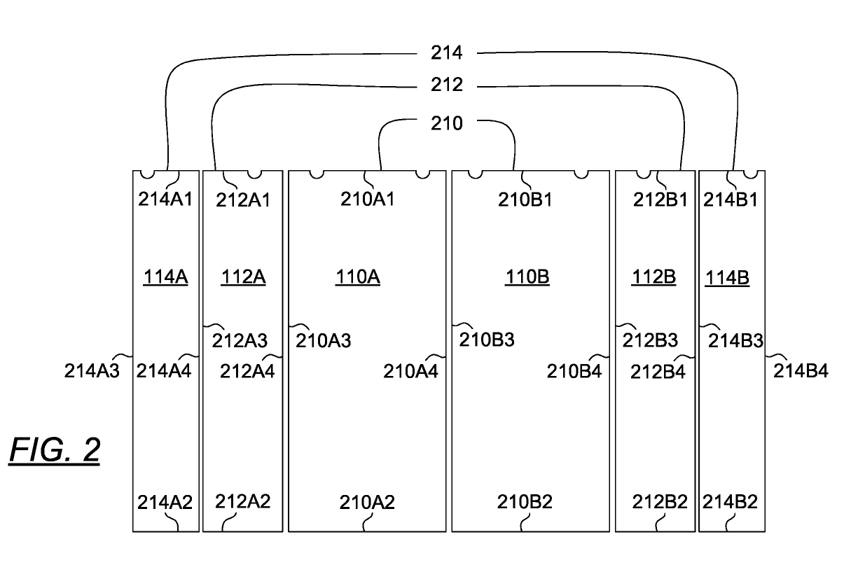

FIG. 2 illustrates a front view of the sheet folding device depicting a first folding panel pair 210 having first panel 110A and a second panel 110B, a second folding panel pair 212 having a first panel 112A and a second panel 112B, and a third folding panel pair having a first panel 114A and a second panel 114B.

The first panel 110A of first folding panel pair 210 comprises a top edge 210A1 having a first cut-out 110A1 and a second cut-out 110A2, a bottom edge 210A2, a left edge 210A3, and a right edge 210A4. The second panel 110B of first folding panel pair 210 is substantially a mirror image of first panel 110A, and comprises a top edge 210B1 having a first cut-out 110B1 and a second cut-out 110B2, a bottom edge 210B2, a left edge 210B3, and a right edge 210B4.

The first panel 112A of second folding panel pair 212 comprises a top edge 212A1 having a first cut-out 112A1, a bottom edge 212A2, a left edge 212A3, and a right edge 212A4. The second panel 112B of second folding panel pair 212 is substantially a mirror image of first panel 112A, and comprises a top edge 212B1 having a first cut-out 112B1, a bottom edge 212B2, a left edge 212B3, and a right edge 212B4.

The first panel 114A of third folding panel pair 214 comprises a top edge 214A1 having a first cut-out 114A1, a bottom edge 214A2, a left edge 214A3, and a right edge 214A4. The second panel 114B of second folding panel pair 214 is substantially a mirror image of first panel 114A, and comprises a top edge 214B1 having a first cut-out 114B1, a bottom edge 214B2, a left edge 214B3, and a right edge 214B4.

Referring to FIGS. 1A, 1B and 2, the connections among first, second, and third panel pairs 210, 212, and 214 respectively are as follows, right edge 214A4 of first panel 114A of third folding panel pair (3FP) 214 is hingedly connected to left edge 212A3 of first panel 112A of second folding panel pair (2FP) 212. The right edge 212A4 of first panel 112A of 2FP 212 is hingedly connected to left edge 210A3 of first panel 110A of first folding panel pair (1FP) 210. The right edge 210A4 of first panel 110A of (1FP) 210 is hingedly connected to the left edge 210B3 of second panel 110B of (1FP) 210. The right edge 210B4 of second panel 110B4 of first folding panel pair (1FP) 210 is hingedly connected to the left edge 212B3 of second panel 112B of (2FP) 212. The left edge 212B4 of second panel 112B of (2FP) 212 is hingedly connected to the left edge 214B3 of second panel 114B of (3FP) 214.

As will be apparent, the size of the overall sheet folding device and its components can vary in size, as long as the basic intra-panel relationships are maintained, therefore the device can be adapted to most any series of standard sizes associated with a particular sheet type product as well as non-standardized products.

The basic intra-panel relationships among the individual panels are exemplified in FIG. 1B and FIG. 2. Shown is the folding panel pairs increase in size starting with the outermost panels located on the extreme left and right, and progressing to the center panel pair. Such a size coordinated panel progression or layout, configures a nested array that enables the folding and inline nesting of the folding multiple panel pairs atop of one another.

For example the sizing scheme of certain product may be delineated by the nomenclature or terms: small, medium and large, or compact, standard, and full, and so forth. In the area of bedding, the sizing scheme of sheet based products is dictated by a unique set of terms. The jargon used in this industry includes the basic terms: twin, full, queen, king, where each term is associated with a narrow set of rectangular dimensions for a given fitted sheet, flat sheet, comforter, duvet/quilt, etc. The rectangular dimensions associated with each of the terms can vary significantly depending on the type of bed (e.g. standard box spring based, waterbed, etc.), as well as the country of original design (e.g. U.S.A., U.K., E.U., etc.). This disclosure will primarily focus on the bedding standard of the U.S.A. for standard box spring/mattress type systems, with the understanding that achieving functionality with other sizing systems can be had by simple corresponding dimensional alterations of the sheet folding device. The basic dimensions for flat and fitted sheet products for bedding applications in the U.S.A. are presented in Table 1.

TABLE 1
Basic dimensions (INCHES) for flat and fitted in the U.S.A.

| Sheet Term | Fitted Sheet | Flat Sheet | Generic Term |
|---|---|---|---|
| Twin | 39 × 76 × 8 | 72 × 102 | Small |
| Full | 54 × 76 × 8 | 87 × 102 | Medium |
| Queen | 60 × 80 × 8 | 105 × 110 | Medium |
| Eastern King | 76 × 80 × 8 | 110 × 114 | Large |
| California King | 73 × 85 × 8 | 110 × 114 | Large |

TABLE 2
Example dimensions (INCHES) for folding device panels

| Panels | Dimensions |
|---|---|
| 110A, 110B | 18 × 39 × ⅛ |
| 112A, 112B | 9 × 39 × ⅛ |
| 114A, 114B | 7½ × 39 × ⅛ |

TABLE 3
Example dimensions (INCHES) for folding panels pairs

| Panel Pairs | Dimension |
|---|---|
| (FIG. 1B) | (Width) |
| 118 | 36½ |
| 120 | 55½ |
| 122 | 71½ |

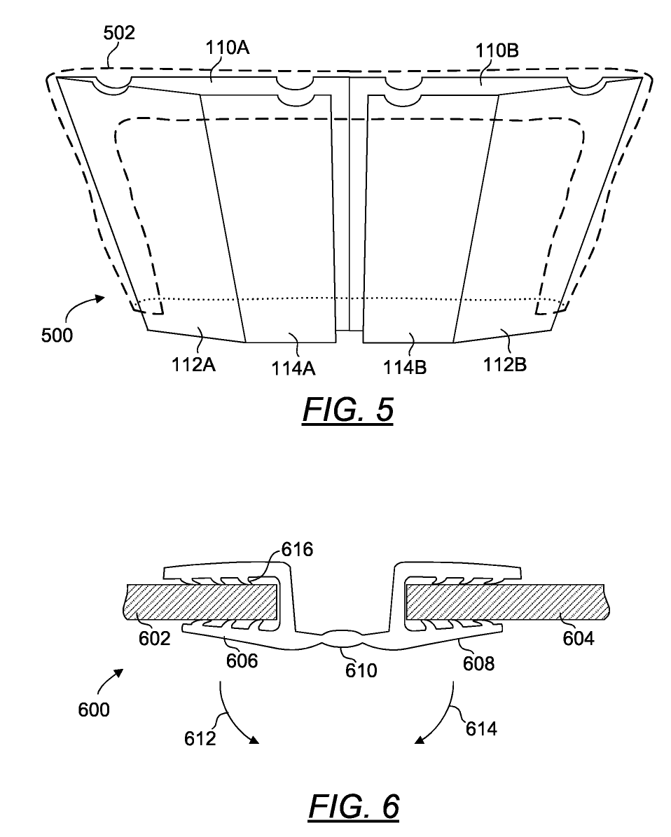

Referring to FIG. 1B, in one embodiment of the present invention the following dimensions are within the working range associated with fitted and flat sheets (U.S.A. measurement system) with approximate standardized dimensions presented in Table. 1. The width associated with both first panel 110A and second panel 110B both have the same width 128 dimension, which is about 18 inches as presented in Table 2. Hinge width 132 is approximated at about ½ an inch, and represents the separation between all adjacent, hingedly connected panels here and throughout the disclosure. Width of first folding panel pair (1FP) 118 is approximately 36 and ½ inches in width (see Table 3) and is designed to substantially approximate the width of “small” sheet products (e.g. Twin, as presented in Table. 1). FIG. 5 depicts sheet folding device 500 configured for small sheet product 502, mounted thereon.

Height of sheet folding device 124 represents the height of all panels (i.e. 110A, 110B, 112A. 112B, 114A, 114B) and hinges 116, whose dimension is approximately 39 inches in height and is designed to be longer than ½ of the sheet product's length, such that the once folded lengthwise sheet product is supported by the sheet folding device without engaging the floor (when the device is used in the upright position). Even though hinges 116 are shown having length 124, other embodiments of the present invention can functionally utilize one or more hinges lengths shorter that length 124. The width associated with both first panel 112A and second panel 112B both have the same width 130 dimension, which is about 9 inches. Likewise, the width associated with both first panel 114A and second panel 114B both have the same width 126 dimensions, which is about 7 and ½ inches. The thickness dimension of all panels in this and all embodiments in this disclosure is about ⅛ inches; the ⅛ inch thickness is a commonly manufactured panel dimension. Other thicknesses can be used, depending on the panel material properties such as stiffness, weight, expense, and the like.

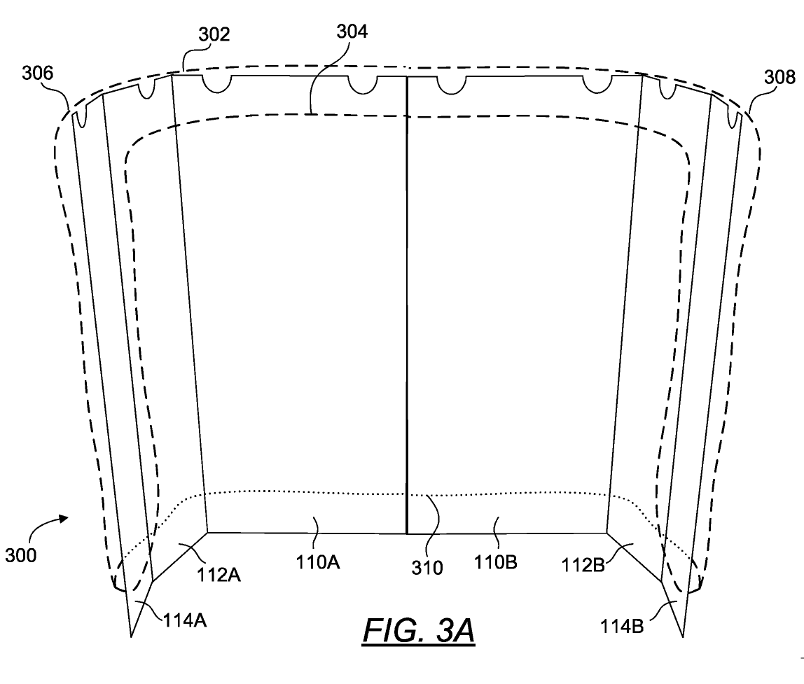

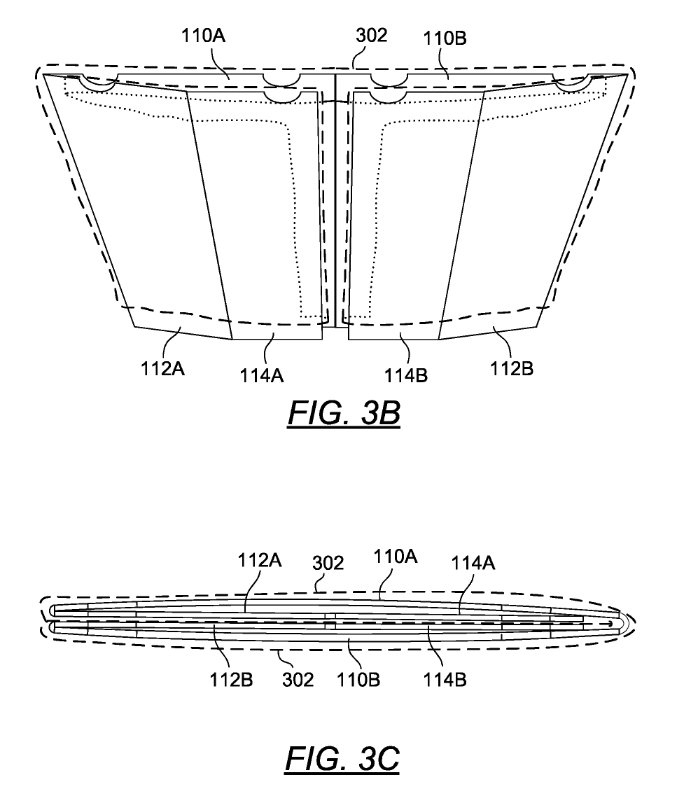

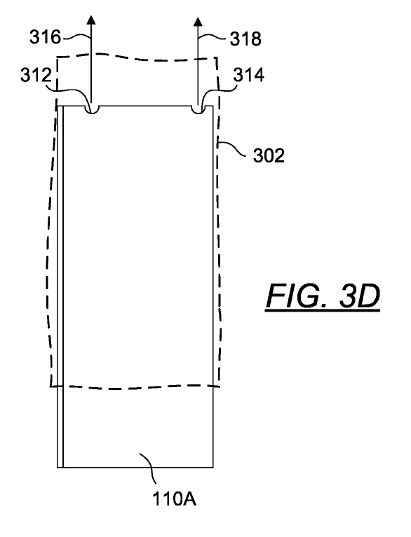

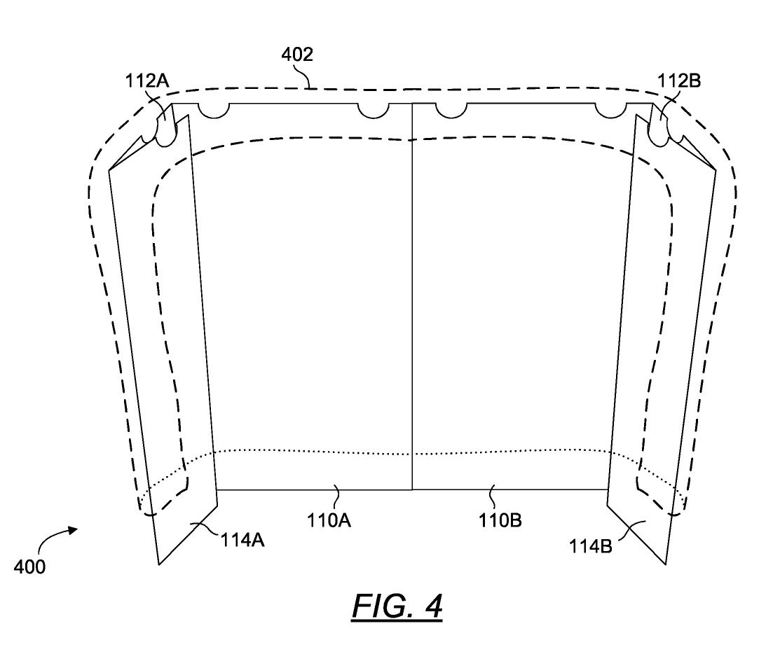

Referring to FIG. 1B, Table 2, and Table 3, the summation of width dimensions associated with panels 110A,112A, 110B and 112B, with corresponding hinge widths 132 yields the overall width of second folding panel pair (2FP) 120. The overall width of second folding panel pair (2FP) 120 is approximately 55 and ½ inches and is designed to substantially approximate the width of “medium” sheet products (e.g. Full, Queen as presented in Table. 1). FIG. 4 depicts sheet folding device 400 configured for small sheet product 402, mounted thereon. Likewise, the summation of width dimensions associated with panels 110A,112A, 110B, 112B, 114A, and 114B with corresponding hinge widths 132 yields the overall width of third folding panel pair (3FP) 122. The overall width of third folding panel pair (3FP) 122 is approximately 71 and ½ inches and is designed to substantially approximate the width of “large” sheet products (e.g. Eastern King, California King as presented in Table. 1). FIG. 3A depicts sheet folding device 300 configured for large sheet product 302, mounted thereon.

FIG. 6 depicts an example panel hinge 600 having a left panel clamp 606 attached to left panel 602, and a right panel clamp 608 attached to right panel 604. Each panel clamp possesses a plurality of holding ribs 616 that functions as a holding means securing the panels to the panel clamps. The left panel clamp 606—left panel 602 assembly moves in folding direction 612, and the right panel clamp 608—right panel 604 assembly moves in folding direction 614, both movements based about the same pivot point or panel hinge center 610.

FIG. 3D depicts a large sheet product 302 mounted on sheet folding device 300 in the completely folded, closed, or home position. In the completely folded, closed, or home position, all cut-outs 110A1, 110A2, 110B1, 110B2, 112A1, 112B1, 114A1, and 114B1 located on panels 110A, 110B, 120A, 120B, 114A, and 114B align into one of either first access channel 312, or second access channel 314. The access channels 312 and 314 provide a means of grabbing and lifting a large sheet product 302 off of sheet folding device 300.

### Additional Features (Not Shown)

Optionally, the cut-out features can be provided on both top and bottom edges of sheet folding device 300, substantially duplicating the means of grabbing and lifting a large sheet product 302 on both ends of sheet folding device 300 enabling the device to be used in either orientation. Additionally, one or more apertures can be located on each of panels 110A, 110B, 120A, 120B, 114A, and 114B such that the plurality of aligning apertures creates a convenience feature. Such a convenience feature can function as a handle to assist the user in transporting the device, as a storage feature enabling the device to be stored on a hook, dowel, etc.; and the like.

### Process or Method of Use

FIGS. 3A, 3B, 3C, and 3D depicts an example process showing how a large sheet product 302 is mounted onto the sheet folding aid device 300, folded, and removed.

To use sheet folding aid device 300, a user would select and arrange the appropriate panels to accommodate the size sheet product to be folded. For small sheet products, panels 112A, 112B, 114A, and 114B, are folded back in the stored position as depicted in FIG. 5; optionally, panels can be added/removed to achieve the proper configuration. For medium sheet products, panels 114A, and 114B, are folded back in the stored position as depicted in FIG. 4; optionally, panels can be added/removed to achieve the proper configuration. For large sheet products, panels all of the panels 110A, 110B, 112A, 112B, 114A, and 114B are used as depicted in FIG. 3A; again, panels can be optionally added/removed to achieve the proper configuration. Once the panel configuration is complete, the user positions the sheet folding device in the open, or semi-open state on level ground in the upright position such that cut-outs are situated on top as depicted in FIG. 3A.

The user would then proceed to the mounting step which involves the preparation of the sheet product followed by the placement onto the sheet folding device. Proper preparation of the sheet product is dependent on the type of sheet product that is to be folded. There are two basic types of sheet products, the fitted sheet product that possesses a box like generally rectangular geometry in its functional state, and the flat sheet that is a generally rectangular, planar, textile based article. In the case of a fitted sheet product, preparation would comprise folding the sheet product about its elongated dimension such that the width is unchanged while the elongated dimension is substantially halved. In addition, the user would ensure the alignment and nesting of the bottom two fitted corners of the fitted sheet product into the top two fitted corners thereof enabling placement of first nested fitted corner assembly 306 and second nested fitted corner assembly 308 onto sheet folding device 300 as depicted in FIG. 3A. The preparation of a flat sheet product would comprise draping the elongated side of the flat sheet product over the sheet folding device 300 such that it is substantially centered about front face of sheet folding device 102 and back face of sheet folding device 104. The flat sheet product can be optionally folded about its width dimension to correspond with the folded panel pair of choice prior to placement onto the prearranged panel configuration of the sheet folding device. A properly mounted sheet product should not engage the ground.

Continuing with the folding of a large sheet product 308 depicted in FIG. 3A, once the sheet product is mounted onto the sheet folding device, the user can commence with the folding process. The folding process, in the folding of a large sheet product example, starts with the folding of both the first panel of (2FP) 112A and first panel of (3FP) 114A moving in unison toward first panel of (1FP) 110A, and the folding of second panel of (2FP) 112B and second panel of (3FP) 114B moving in unison toward second panel of (1FP) 110B, ultimately arriving at the configuration depicted in FIG. 3B.

The next step in the folding process is the folding of the configuration depicted in FIG. 3B to the home position depicted in FIG. 3C; this is accomplished by folding the 110A, 112A, 114A nested assembly toward the 110B, 112B, 114B nested assembly.

The user then grabs onto the stacked vertical layers of the large sheet product 302 using a pinching action via first access channel 312 and second access channel 314 and lifting in the first access channel sheet removal direction 316 and second access channel sheet removal direction 318, respectively; best depicted in FIG. 3D.

Next in the sequence is the user folding the portion of the large sheet lifted off of folding device in a downward direction away from the user such that a series of horizontal folds are created atop of remaining sheet portion remaining on folding device. Optionally the folding device can be tilted backward toward the user to facilitate this step. The user repeats the lifting and folding steps until the large sheet product is completely removed from the folding device and in a uniform folded condition.

What is claimed herein is:

1. A sheet folding device, comprising: a first folding panel pair having a first panel and a second panel each being generally rectangular, thin, rigid, and of similar size, having a short dimension, an elongated dimension, a top edge and a bottom edge, and two side edges, wherein
one of said two side edges located about said elongated dimension of said first panel is hingedly connected to one of said two side edges located about said elongated dimension of said second panel so to form an assembly that substantially accommodates a range of sizes considered small in the series of standard commercial sizes associated with generally rectangular sheet based products, and
said top edges of both said first panel and said second panel each possess a pair of cut outs such that when said first panel and said second panel is folded to a closed position, said pair of cut outs align, creating a pair of access channels, thereby providing a user with a sheet grasping means.

2. The sheet folding device of claim 1 further comprising a second folding panel pair having a third panel and a fourth panel each being generally rectangular, thin, rigid, and of similar size, having a short dimension that is smaller than said short dimension of said first and said second panel, an elongated dimension substantially equal to said elongated dimension of said first and said second panel, a top edge and a bottom edge, and two side edges, wherein
one of said two side edges located about said elongated dimension of said third panel and said fourth panel are hingedly connected to the remaining unoccupied said side edge located about said elongated dimension of said first panel and said second panel respectively, so to form an assembly that substantially accommodates a range of sizes considered medium in the series of standard commercial sizes associated with generally rectangular sheet based products, and
said top edges of both said third and said fourth panels both possess a cut out such that when said first, said second, said third, and said fourth panels are folded to a closed position, all said cut outs align, creating a pair of access channels, thereby providing a user with a sheet grasping means.

3. The sheet folding device of claim 2 further comprising a third folding panel pair having a fifth panel and a sixth panel each being generally rectangular, thin, rigid, and of similar size, having a short dimension that is smaller than said short dimension of said third and said fourth panels, an elongated dimension substantially equal to said elongated dimension of said first, said second, said third, and said fourth panels, a top edge and a bottom edge, wherein
one of said side edges located about said elongated dimension of said fifth panel and said sixth panels are hingedly connected to the remaining unoccupied said side edge located about said elongated dimension of said third panel and said fourth panel respectively so to form an assembly that substantially accommodates a range of sizes considered large in the series of standard commercial sizes associated with generally rectangular sheet based products, and
said top edges of both said fifth and said sixth panels both possessing a cut out such that when said first, said second, said third, said fourth, said fifth, and said sixth panels are folded to a closed position, all said cut outs align creating a pair of access channels, thereby providing a user with a sheet grasping means.

4. The sheet folding device of claim 3 further comprising said first, said second, said third, said fourth, said fifth, and said sixth panels all integrated and constructed from a single piece of polymeric material having a plurality of living hinges at predetermined locations.

5. The sheet folding device of claim 1 wherein said first panel is removably attached to said second panel.

6. The sheet folding device of claim 2 wherein said second folding panel pair is removably attached to said first folding panel pair.

7. The sheet folding device of claim 3 wherein said third folding panel pair is removably attached to said second folding panel pair.

8. The sheet folding device of claim 3 wherein said sheet folding device is substantially constructed out of a polymeric material.

9. A sheet folding device configured as a nestable array of hingedly connected panels, comprising: a centrally located first folding panel pair having a first panel and a second panel, a second folding panel pair having a third panel and a fourth panel, and a third folding panel pair having a fifth panel and a sixth panel, wherein each said pair of said panels associated with each said folding panel pair are generally rectangular, thin, rigid, and of similar size, having a short dimension, an elongated dimension, a top edge and a bottom edge, and two side edges, wherein
said centrally located first folding panel pair is adjacently adjoined to said second folding panel pair, and said second folding panel pair is adjacently adjoined to said third folding panel pair.

10. The sheet folding device of claim 9 further comprising a first folding panel pair having overall dimensions adapted to a range of sizes considered small in the series of standard commercial sizes associated with generally rectangular sheet based products;
a medium size nestable array having essentially the overall dimensions of said second folded panel pair adjacently adjoined to said first folded panel pair, wherein said medium size nestable array is adapted to a range of sizes considered medium in the series of standard commercial sizes associated with generally rectangular sheet based products;
a large size nestable array having essentially the overall dimensions of said third folded panel pair adjacently adjoined to said second folded panel pair which is also adjacently adjoined to said first folded panel pair, wherein said large size nestable array is adapted to a range of sizes considered large in the series of standard commercial sizes associated with generally rectangular sheet based products;

11. The sheet folding device of claim 9 further comprising at least one cut out located on said top edge of each of said first, said second, said third, said fourth, said fifth, and said sixth panels such that when all said panels are folded to a closed position, said plurality of cut outs align, creating a pair of access channels, thereby providing a user with a sheet grasping means.

12. The sheet folding device of claim 11 wherein said sheet folding device is substantially constructed out of a polymeric material.

13. The sheet folding device of claim 9 further comprising a nestable array of hingedly connected panels that are removeably attachable.

14. The sheet folding device of claim 9 further comprising a nestable array of hingedly connected panels that are permanently affixed.

15. The sheet folding device of claim 9 further comprising said first, said second, said third, said fourth, said fifth, and said sixth panels all integrated and constructed from a single piece of polymeric material having a plurality of living hinges at predetermined locations.
